(19) United States
(12) Patent Application Publication
(10) Pub. No.: US 2023/0206936 A1
(43) Pub. Date: Jun. 29, 2023

(54) AUDIO DEVICE WITH AUDIO QUALITY DETECTION AND RELATED METHODS

(71) Applicant: GN Audio A/S, Ballerup (DK)

(72) Inventors: Clément Laroche, Ballerup (DK); Pejman Mowlaee, Ballerup (DK); Rasmus Kongsgaard Olsson, Ballerup (DK)

(21) Appl. No.: 18/062,815

(22) Filed: Dec. 7, 2022

(30) Foreign Application Priority Data
Dec. 29, 2021 (EP) 21218154.9

(51) Int. Cl. G10L 21/0208

(52) U.S. Cl. CPC G10L 21/0208; G10L 2021/02082

(57) ABSTRACT

An audio device and related methods for speech quality detection are disclosed, the audio device comprising an interface, a processor, a memory and one or more microphones, wherein the audio device is configured to obtain, via the interface, a microphone input signal from one or more microphones including a first microphone; process the microphone input signal for provision of an output signal; determine, using a non-intrusive quality detection model, one or more quality parameters including a first quality parameter indicative of a speech quality associated with the output signal; control processing of the microphone input signal based on the first quality parameter; and transmit, via the interface, the output signal.

The present disclosure relates to an audio device and related methods in particular audio quality detection.

### BACKGROUND

In general, the speech quality of a transmitted audio signal is based on the acoustic configuration, the digital processing, the background noise, and the room reverberation. Further, the speech quality of an audio signal is based on the signal to noise ratio, SNR, distance to the speaker from the microphone, loss of speech data, Interfering speech, noise, echo annoyance, the position of the speaker in an acoustic environment, etc.

Considering all the factors, it is very often the case that the transmitted audio signal is not of certain good quality. For example, in a speaker-audio device setup, when the user is located far from the microphone, the speech signal picked up by the microphone of the audio device is of low signal to noise ratio, SNR, and very likely reverberant. Both factors degrade the speech quality of the transmitted audio signal. In a wireless headset scenario, there could be changes in the audio signal quality due to the background noise and the acoustic echoes, and/or due to room reverberation and/or a jammer speech, such as interfering speech. Further, due to digital signal processing, there may be a change in the speech quality of transmitted audio signal. In general, this may happen without the influence of the user of the wireless headset.

In all such scenarios, the far-end user (the user) will experience discomfort due to the degraded speech quality and loss of audio information.

### SUMMARY

Accordingly, there is a need for audio devices and methods with improved audio quality detection, such as determining the quality of the audio signal before transmission and improve the quality of the audio signal (e.g., by noise suppression in the audio signal, suppressing the interfering speech, and/or suppressing the room reverberations).

An audio device for speech quality detection is disclosed, the audio device comprising an interface, a processor, a memory and one or more microphones, wherein the audio device is configured to obtain, via the interface, a microphone input signal from one or more microphones including a first microphone; process the microphone input signal for provision of an output signal; determine, using a non-intrusive quality detection model, one or more quality parameters including a first quality parameter indicative of a speech quality associated with the output signal; control processing of the microphone input signal based on the first quality parameter; and transmit, via the interface, the output signal.

Further, a method for speech quality detection in an audio device is disclosed, the method comprising: obtaining a microphone input signal from one or more microphones including a first microphone; processing the microphone input signal for provision of an output signal; determining one or more quality parameters including a first quality parameter indicative of a speech quality associated with the output signal; controlling the processing of the microphone input signal based on the first quality parameter; and transmitting the output signal.

Also, disclosed is a computer-implemented method for training a quality detection model for audio quality estimation. The method comprising obtaining an audio dataset comprising one or more audio signals; obtaining a score dataset comprising one or more reference quality parameters including a first reference quality parameter indicative of audio quality associated with the one or more audio signals; determining, by applying the quality detection model to the one or more audio signals, one or more quality parameters including a first quality parameter indicative of audio quality associated with the one or more audio signals; and training, based on the one or more audio signals, the one or more reference quality parameters, and the one or more first quality parameters, the quality detection model.

The present disclosure provides an improved communication experience, for example, during a telephone conversation, a conference call, and/or while using a headset for communication. The present disclosure leads to an improved speech communication experience by determining the quality of transmitting and/or receiving an audio signal and control the processing based on the speech quality. The audio device can be configured to improve the quality of the speech in an audio signal based on the speech quality associated with the transmitting and/or receiving audio signal, this in turn improves the communication experience.

The present disclosure allows for the quality detection of an audio signal without having access to a reference signal. Further, the present disclosure allows for quality detection of an audio signal in real-time and quality improvement in real time, which in turn provides an improved speech communication experience. In other words, the present disclosure allows to detect the quality of an audio signal before transmitting to an end user and improves the quality of the audio signal, for example, by performing noise suppression and/or echo cancellation on the audio signal, such as the microphone input signal and/or the output signal.

Further, it is an advantage of the present disclosure that dynamic feedback on the speech quality in the microphone input signal (and/or output signal) to the user of the audio device is provided, this in turn helps to perform appropriate actions, such as by activating the digital signal processing circuitry and/or schemes, to reduce the speech quality degradation and/or improve the speech quality in an audio signal. Further, it is an advantage of the present disclosure that it provides recommendations to take decisions in the control logic unit about what feature(s) or logic circuitry, such as a digital signal processing logic circuitry, should be activated to improve the speech quality in an audio signal.

### BRIEF DESCRIPTION OF THE DRAWINGS

The above and other features and advantages of the present invention will become readily apparent to those skilled in the art by the following detailed description of example embodiments thereof with reference to the attached drawings, in which:

FIG. 1 schematically illustrates an example audio system according to the disclosure,

FIG. 2 is a flow diagram of an example method according to the disclosure,

FIG. 3 is a flow diagram of an example computer-implemented method according to the disclosure,

FIG. 4 schematically illustrates an example system for an audio dataset and a score dataset generation according to the disclosure, and

FIG. 5 schematically illustrates an example training system for training a quality detection model according to the disclosure.

### DETAILED DESCRIPTION

Various example embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

An audio device for speech quality detection is disclosed, the audio device comprising an interface, a processor, and a memory.

In one or more example audio devices, the audio device may comprise one or more interfaces, one or more processors, and one or more memories. Further, the audio device may comprise one or more microphones, such as a first microphone, optionally a second microphone, optionally a third microphone and optionally a fourth microphone. The audio device may comprise one or more audio speakers.

The audio devices may be one or more of a headset, an audio signal processor, a headphone set, a hearing aid, a computer, a mobile phone, a tablet, a server, a microphone, and/or a smart speaker. The audio device may be a single audio device. The audio device may be a plurality of interconnected audio devices, such as a system, such as an audio system. The audio system may comprise one or more users. It is noted that the term speaker may be seen as the user of the audio device. The audio device may be configured to process one or more audio signals. The audio device can be configured to output audio signals. The audio device may be configured to obtain, such as to receive via the interface, the audio signals.

The audio device is configured to obtain, via the interface, a microphone input signal from one or more microphones including a first microphone.

In one or more example audio devices, the interface comprises a wireless transceiver, also denoted as a radio transceiver, and an antenna for wireless transmission and reception of an audio signal, such as for wireless transmission of the output signal and/or wireless reception of a wireless input signal. The audio device may be configured for wireless communication with one or more electronic devices, such as another audio device, a smartphone, a tablet, a computer and/or a smart watch. The audio device optionally comprises an antenna for converting one or more wireless input audio signals to antenna output signal(s). In one or more example audio devices, the interface comprises the one or more more microphones.

In one or more example audio devices, the interface may comprise a connector for wired communication, via a connector, such as by using an electrical cable. The connector may connect one or more microphones to the audio device.

The one or more interfaces can be or comprise wireless interfaces, such as transmitters and/or receivers, and/or wired interfaces, such as connectors for physical coupling. For example, the audio device may have an input interface configured to receive data, such as a microphone input signal. In one or more example audio devices, the audio device can be used for all form factors in all types of environments, such as for headsets and/or video conference equipment. For example, the audio device may not have a specific microphone placement requirement. In one or more example audio devices, the audio device may comprise a microphone boom, wherein one or more microphones are arranged at a distal end of the microphone boom.

In one or more example audio devices, the audio device may be configured to obtain a microphone input signal from one or more microphones, such as a first microphone, a second microphone, a third microphone and/or a fourth microphone. In one or more example audio devices, the microphone input signal may be obtained from the first microphone. In one or more example audio devices, the microphone input signal may be a combined input signal obtained from two or more of the first microphone, the second microphone, the third microphone, and the fourth microphone.

In one or more example audio devices, the microphone input signal may be indicative of an audio signal generated by user(s) of the audio device. In one or more example audio devices, the microphone input signal may be indicative of an audio signal generated by the user(s) of the audio device while using the audio device. In other words, the microphone input signal may be indicative of user speech. In one or more example audio devices, the microphone input signal may comprise one or more of the user's speech, such as a user speech in a near-field, interfering speech, such as a jamming speech from one or more speakers in the far-field, noise ,such as ambient noise, continuous noise, intermittent noise, impulsive noise, and/or low-frequency noise, and/or echo of one or more of the user's speech, interfering speech, and noise.

In one or more example audio devices, the audio device may be configured to obtain the microphone input signal from a distant microphone which is connected wirelessly with the audio device. In one or more example audio devices, the audio device may be configured to obtain the microphone input signal from a distant microphone which is connected to the audio device via a cable, such as an audio cable and/or an electrical cable. In one or more example audio devices, the user of the audio device may present within 10 meters range from the audio device while using the audio device. In an example scenario, a user may be using an audio device, such as a smart speaker for communication, positioned 10 meters apart. The audio device may be configured to obtain the user's speech, such as user commands, such as the user voice commands.

The audio device is configured to process the microphone input signal for provision of an output signal.

In one or more example audio devices, the output signal may comprise the microphone input signal.

In one or more example audio devices, the processor of the audio device may be configured to process the microphone input signal. In one or more example audio devices, the processing of the microphone input signal may comprise a first processing of the microphone input signal for provision of the output signal. The output signal may be indicative of a noise suppressed microphone input signal. In other words, the first processing of the microphone input signal may comprise cancelling the noise, such as noise suppression in the microphone input signal.

The output signal may be indicative of an echo suppressed microphone input signal. In other words, the first processing of the microphone input signal may comprise cancelling the echo, such as echo suppression, in the micro phone input signal.

In one or more example audio devices, the output signal may be the output of a digital signal processing, DSP, logic. In one or more example audio devices, the processor of the audio device may comprise a DSP logic.

The output signal may be indicative of noise and echo suppressed microphone input signal. In other words, the first processing of the microphone input signal may comprise cancelling the noise and the echo in the microphone input signal. In one or more example audio devices, the output signal may be based on or constituted by the output of a digital signal processing, DSP, logic.

In one or more example audio devices, the DSP logic may comprise one or more filters to process the microphone input signals. In one or more example audio devices, the DSP logic is configured to change one or more weights associated with the filters based on the one or more quality parameters, such as the first quality parameter. In one or more example audio devices, the DSP logic may comprise a neural network, such as a cascading neural network, which may receive the one or more quality parameters as input. The DSP logic may process the microphone input signals based on the output being filter coefficients and/or processing scheme identier(s) of the cascading neural network. In one or more examples, the DSP logic may be configured to select a processing scheme/filter coefficients based on the first quality parameter and/or the second quality parameter.

The audio device is configured to determine, using a non-intrusive quality detection model, one or more quality parameters including a first quality parameter indicative of a speech quality associated with the output signal.

In one or more example audio devices, the processor, such as a features extractor of the processor, of the audio device may be configured to extract or determine one or more features. For example, the processor of the audio device may be configured to extract or determine one or more output features of the output signal or scores associated with respective output features, such as one or more of a first output feature, a second output feature, a third output feature, a fourth output feature, a fifth output feature, and a sixth output feature. For example, the processor of the audio device may be configured to extract or determine one or more input features of the microphone input signal or scores associated with respective input features, such as one or more of a first input feature, a second input feature, a third input feature, a fourth input feature, a fifth input feature, and a sixth input feature.

In one or more example audio devices, a feature, such as the first output feature and/or the first input feature, may be noisiness.

In one or more example audio devices, a feature, such as the second output feature and/or the second input feature, may be speech clarity.

In one or more example audio devices, a feature, such as the third output feature and/or the third input feature, may be echo annoyance.

In one or more example audio devices, a feature, such as the fourth output feature and/or the fourth input feature, may be signal-to-noise ratio, SNR.

In one or more example audio devices, a feature, such as the fifth output feature and/or the fifth input feature, may be reverberation, delay properties due to room characteristics, spatial characteristics, or source-to-receiver characteristics.

In one or more example audio devices, a feature, such as the sixth output feature and/or the sixth input feature, may be reverberation, delay properties due to room characteristics, spatial characteristics, or cue preservation.

In one or more example audio devices, the processor of the audio device may be configured to determine, using a non-intrusive quality detection model, one or more quality parameters, such as one or more of a first quality parameter, and a second quality parameter, indicative of a speech quality associated with the output signal and/or the microphone input signal. In one or more example audio devices, the first quality parameter may be indicative of speech quality, such as a mean opinion score (MOS), associated with the output signal. In one or more example audio devices, the second quality parameter may be indicative of speech quality, such as a mean opinion score (MOS), associated with the microphone input signal.

In one or more example audio devices, the mean opinion score may be an algorithmically estimated mean opinion score.

In one or more example audio devices, determining the one or more quality parameters of the output signal may comprise determining the one or more quality parameters non-intrusively (i.e., without depending on a reference signal), e.g. based on the output signal and/or one or more output features of the output signal. Thus, one or more output features may be fed as input to the non-intrusive quality detection model.

In one or more example audio devices, determining the one or more quality parameters of the microphone input signal may comprise determining the one or more quality parameters non-intrusively (i.e., without depending on a reference signal), e.g. based on the microphone input signal and/or one or more input features of the microphone input signal. Thus, one or more input features may be fed as input to the non-intrusive quality detection model.

In one or more example audio devices, the non-intrusive quality detection model may be stored in a part of the memory of the audio device. In one or more example audio devices, the processor of the audio device may be configured to access the non-intrusive quality detection model stored in the memory. The non-intrusive quality detection model may be seen as machine learning model. The machine learning model may comprise a neural network. In one or more example audio devices, the neural network may be a trained neural network.

It is an advantage of the present disclosure that the need for a reference signal, such as a reference audio signal, to determine the quality of an audio signal is alleviated.

In one or more example audio devices, the first quality parameter may be indicative of a mean opinion score, MOS. The mean opinion score may be seen as a numerical value, such as an integer, a float value, a whole number, a real number, a rational number, and/or a natural number. The mean opinion score may be based on one or more input features of the microphone input signal and/or one or more output features of the output signal.

In one or more example audio devices, the speech quality may be seen as the quality of the audio device user's speech, such as words, sentences, and sounds that the user speak while using the audio device. In one or more example audio devices, a speech with good speech quality may be seen as the speech that is audible and/or understandable by the far-end party, such as another user of another audio device, during the communication, such as during a voice-based communication, such as a phone conversation or a telephone conference.

The audio device may be configured to control processing of the microphone input signal based on the first quality parameter.

In one or more example audio devices, the processor of the audio device may be configured to control the processing of the microphone input signal based on the one or more quality parameters, such as the first quality parameter and/or the second quality parameter.

In one or more example audio devices, controlling, based on the first quality parameter, the processing of the microphone input signal comprises determining whether the first quality parameter satisfies a first criterion. In other words, controlling, based on the first quality parameter, the processing of the microphone input signal may be based on whether the mean opinion score, MOS satisfies a first criterion. The MOS score, such as input MOS, may be based on the input quality parameter associated with the microphone input signal. The MOS score, such as output MOS, may be based on the output quality parameter associated with the output signal. The processing of the microphone input signal may be based on whether the input MOS and/or output MOS satisfies the first criterion.

In one or more example audio devices, the first criterion comprises a first threshold. In one or more example audio devices, determining whether the first quality parameter satisfies a first criterion is based on determining whether the first quality parameter is above the first threshold, such as determining whether the mean opinion score is above the first threshold. In one or more example audio devices, when the first quality parameter is above or equal to the first threshold, i.e., the MOS is above or equal to the first threshold, then it is considered that the first quality parameter satisfies the first criterion. In other words, the speech quality associated with the output signal may be considered as good. In one or more example audio devices, when the first quality parameter satisfies the first criterion then there is no processing of the microphone input signal is needed. In one or more example audio devices, the first threshold may be a predetermined value. In one or more example audio devices, the first threshold may be dynamically determined by the audio device based on the historical data, such as the conditions in which the audio device is used by the user.

In one or more example audio devices, when the first quality parameter is below the first threshold (i.e., the MOS is below the first threshold), then it is considered that the first quality parameter does not satisfy the first criterion. In other words, the speech quality associated with the output signal may be considered as not good. In one or more example audio devices, when the first quality parameter does not satisfy the first criterion then the processor is configured to process the microphone input signal to improve the speech quality, such as by processing the one or more features of the microphone input signal to improve the mean opinion score. In one or more example audio devices, when the first quality parameter does not satisfy the first criterion then it may be considered as that the speech of the audio device user may not be clear and/or not audible to the far-end party.

In one or more example audio devices, the audio device may comprise a digital signal processing, DSP, circuitry. In one or more example audio devices, the processing of the microphone input signal may be performed by the digital signal processing unit, such as digital signal processing circuitry. In one or more example audio devices, the processor of the audio device may be configured to control the digital signal processing circuitry based on the first quality parameter of the output signal.

In one or more example audio devices, processing the microphone input signal is needed, when the first quality parameter does not satisfy the first criterion, for provision of an output signal with improved mean opinion score. In one or more example audio devices, the processor may be configured to determine, using the non-intrusive quality detection model, a first quality parameter indicative of a speech quality associated with the output signal. In one or more example audio devices, the processor may be configured to determine, using the non-intrusive quality detection model, a second quality parameter indicative of a speech quality associated with the microphone input signal. In one or more example audio devices, the speech quality of the output signal may be higher than the speech quality of the microphone input signal. In other words, the mean opinion score associated with the output signal may be higher than the microphone input signal. In one or more example audio devices, the difference between the mean opinion scores associated with the output signal and the microphone input signal may be indicative of change, such an increase or decrease, in the speech quality associated with the microphone input signal.

The audio device is configured to transmit, via the interface, the output signal.

In one or more example audio devices, the audio device may be configured to transmit the output signal. The audio device may transmit the output signal via a wireless transceiver and/or a wired connector of the audio device. In one or more example audio devices, the audio device may transmit the output signal to an electronic device, such as another audio device, a mobile phone, a tablet, a computer, a smartwatch, a server, a cloud-based server, a smart speaker and/or a loudspeaker.

In one or more example audio devices, the transmitted output signal may comprise the microphone input signal. The output signal may comprise the microphone input signal when the first quality parameter of the microphone input signal satisfies the first criterion. In other words, the microphone input signal may have a good speech quality.

In one or more example audio devices, the audio device is configured to determine and output a feedback, e.g. via an audio speaker of the audio device/interface, to the audio device user based on the first quality parameter associated with the output signal and/or the second quality parameter associated with the microphone input signal. The feedback may comprise a first feedback indicative of the speech quality of the output signal. The feedback may comprise a second feedback indicative of desired speech quality needed for a good communication. The feedback may comprise a third feedback indicative of the impact of acoustic configuration of surroundings on the speech quality of the microphone input signal and/or the output signal. In an example scenario, a user is using an audio device in a large room with concrete walls and ventilation with no soundproofing. When the user is using the audio device to communicate, the microphone(s), such as the first microphone, obtains a microphone input signal. The microphone input signal may be affected by the noise from surroundings and/or the echo of the user's speech. The audio device is configured to determine, using a non-intrusive quality detection model, one or more quality parameters, such as the first quality parameter, indicative of speech quality associated with the microphone input signal. The quality parameter may be indicative of the mean opinion score, which is based on one or more input features associated with the microphone input signal. When the mean opinion score is below certain threshold value, the audio device notifies the audio device user about the quality of the microphone input signal and/or output signal, suitability of the room for communication, the acoustic configuration of the surroundings, and/or the influence of the noise on the microphone input signal. The user may change the position or change room to improve the speech quality in the microphone input signal. The audio device may be configured to provide the feedback by generating an alert sound, such as generating an alert tone or playing a recorded message from the memory. The audio device may be configured to provide the feedback by transmitting the feedback or feedback data to one or more user devices, such as the electronic devices that user is connected to, for example, a mobile phone, a laptop, a smartwatch and/or a display. In one or more example audio devices, the audio device may be configured to provide the feedback by via a side tone signal path of the audio device.

It is an advantage of the present disclosure that feedback on the speech quality and impact of the acoustic surroundings on the speech quality may be provided to the user of the audio device. The feedback may be dynamic feedback. In one or more example audio devices, the audio device provides feedback to the user when the mean opinion score drops below a certain threshold.

In one or more example audio devices, the first quality parameter is a mean opinion score.

In one or more example audio devices, the audio device may be configured to determine the first quality parameter based on the one or more features of the output signal also denoted output features. In one or more example audio devices, the audio device may be configured to determine the mean opinion score based on the one or more features of the output signal.

In one or more example audio devices, the audio device may be configured to determine the second quality parameter based on the one or more features of the microphone input signal also denoted input features. In one or more example audio devices, the audio device may be configured to determine the mean opinion score based on the one or more features of the microphone input signal.

In one or more example audio devices, the first quality parameter and/or the second quality parameter may be indicative of one or more of speech distortion, noise attenuation, and echo annoyance.

In one or more example audio devices, the speech distortion in the microphone input signal may be seen as unclear speech (due to change in the audio waveform by noise) delivered by the audio device user. In one or more example audio devices, the speech quality may be based on signal to noise ratio, SNR, noise to voice ratio, reverberation time, such as RT60.

In one or more example audio devices, determining, using a non-intrusive quality detection model, the one or more quality parameters, such as the second quality parameter, may be based on the speech distortion in the microphone input signal.

In one or more example audio devices, determining, using a non-intrusive quality detection model, the one or more quality parameters, such as the second quality parameter, may be based on the noise attenuation associated with the microphone input signal.

In one or more example audio devices, determining, using a non-intrusive quality detection model, the one or more quality parameters, such as the first quality parameter and the second quality parameter, may be based on the echo annoyance associated with the microphone input signal and/or the output signal

In one or more example audio devices, determining the one or more quality parameters comprises to apply the non-intrusive quality detection model to a model input based on one or both of the output signal and the microphone input signal.

In one or more example audio devices, the processor of the audio device may be configured to determine one or more quality parameters, such as the first quality parameter, by applying the non-intrusive quality detection model to a model input.

In one or more example audio devices, the model input may comprise the output signal.

In one or more example audio devices, the model input may comprise the microphone input signal. In one or more example audio devices, the model input may comprise both microphone input signal and output signal.

In one or more example audio devices, determining the one or more quality parameters comprises to determine an output quality parameter associated with the output signal and an input quality parameter associated with the microphone input signal.

In one or more example audio devices, the processor of the audio device may be configured to determine, using the non-intrusive quality detection model, an output quality parameter associated with the output signal. In one or more example audio devices, the processor of the audio device may be configured to determine, using the non-intrusive quality detection model, an input quality parameter, such as the second quality parameter, associated with the microphone input signal.

In one or more example audio devices, the audio device may be configured to compare the output quality parameter and the input quality parameter, such as determining the difference between the mean opinion scores associated with the output quality parameter and the input quality parameter, and determining the ratio of the mean opinion score of the output signal in relation to the mean opinion score of the microphone input signal.

In one or more example audio devices, the audio device may be configured to determine, based on the output quality parameter and the input quality parameter, the acoustic configuration of surroundings, e.g., the acoustic information associated with the surroundings, such as determining whether the room in which the user is using the audio device is good for a voice communication or not, and/or determining whether the user is sufficiently close to the microphone or not. In one or more example audio devices, the audio device may be configured to determine acoustic information of the surroundings dynamically. In one or more example audio devices, the audio device may be configured to periodically determine acoustic information of the surroundings, for example, monitoring every 1 s, 2 s, 3 s, 4 s, 5 s, 10 s, 15 s, 20 s, 30 s, 1 min, 2 mins, etc. It is noted that monitoring may be seen as determining acoustic information of the surrounding.

It is an advantage of the present disclosure that determining the change in the mean opinion score associated with the output signal of the audio device and the microphone input signal provides the acoustic information of the surroundings. In other words, determining the change in the features of the output signal and the microphone input signal may provide the acoustic information of the surroundings. Further, the change in the mean opinion score associated with the output signal of the audio device and the microphone input signal may serve as reference to indicate the level of performance of the processing of the microphone input signal. Further, the mean opinion score associated with the microphone input signal may serve as reference to determine whether the surroundings of the speaker/user is a good place for voice communication or not.

In one or more example audio devices, determining the first quality parameter is based on the output quality parameter and the input quality parameter, such as based on a ratio or a difference between the output quality parameter and the input quality parameter.

In one or more example audio devices, the audio device may be configured to determine, using a non-intrusive quality detection model, the first quality parameter based on the output quality parameter associated with the output signal and/or the input quality parameter associated with the microphone input signal.

In one or more example audio devices, the non-intrusive quality detection model comprises a machine leaning model comprising a trained neural network.

In one or more example audio devices, the machine learning model may comprise a neural network. The neural network may be a deep neural network. The neural network, NN, may be a trained neural network. In one or more example audio devices, the neural network may comprise one or more of a feed-forward NN, a bidirectional long short-term memory NN, a 2D-convolutional layers NN, a max pooling NN, a frame wise NN, a dense NN, such as a deep noise suppression NN methods based on mean opinion score (DNSMOS), and MetricNet NN.

In one or more example audio devices, the neural network may comprise one or more input layers, one or more intermediate layers, and one or more output layers. In one or more example audio devices, the one or more input layers of the neural network may receive the microphone input signal as input.

In one or more example audio devices, the one or more input layers of the neural network may receive the output signal as the input.

In one or more example audio devices, the one or more input layers of the neural network may receive the model input as input. In one or more example audio devices, the one or more input layers of the neural network may receive information associated with one or more features of the output signal and/or the microphone input signal as input, for example, the one or more input layers of the neural network may receive the structural features, such as Mel-spectrograms and/or log-power spectrograms, associated with the output signal and/or the microphone input signal as input. In one or more example audio devices, the one or more output layers may provide one or more quality parameters. In other words, the one or more output layers of the neural network may output a mean opinion score as output.

In one or more example audio devices, the neural network may receive one or more of an input quality parameter, a first score, a second score, a third score, a fourth score, a fifth score, a first threshold as input to one or more input layers.

In one or more example audio devices, processing the microphone input signal for provision of an output signal comprises to apply a noise suppression scheme, and to control processing of the microphone input signal based on the first quality parameter comprises to control the noise suppression scheme based on the first quality parameter.

In one or more example audio devices, the audio device may be configured to process, based on the first quality parameter, the microphone input signal for provision of an output signal. In one or more example audio devices, processing the microphone input signal for provision of an output signal comprises controlling the noise suppression scheme based on the first quality parameter, such as the mean opinion score of the output signal. In other words, the audio device may be configured to control, based on the mean opinion score, the noises suppression scheme to process the microphone input signal.

In one or more example audio devices, to process the microphone input signal for provision of an output signal comprises to apply an echo cancellation scheme, and to control processing of the microphone input signal based on the first quality parameter comprises to control the echo cancellation scheme based on the first quality parameter.

In one or more example audio devices, the audio device may be configured to process, based on the first quality parameter, the microphone input signal for provision of an output signal. In one or more example audio devices, processing the microphone input signal for provision of an output signal comprises controlling the echo suppression scheme based on the first quality parameter, such as the mean opinion score associated with the output signal. In other words, the audio device may be configured to control, based on the mean opinion score, the echo suppression scheme to process the microphone input signal.

In one or more example audio devices, determining the one or more quality parameters comprises to determine a first score associated with a first feature of the output signal, wherein the first quality parameter is based on the first score.

In one or more example audio devices, the audio device may be configured to determine, using the non-intrusive quality detection model, the one or more quality parameters, such as the first quality parameter. In one or more example audio devices, determining the first quality parameter comprises determining a first score associated with the first feature of the output signal. In one or more example audio devices, determining the first quality parameter comprises determining a first score associated with the first feature of the microphone input signal, such as the microphone input signal from the first microphone.

In one or more example audio devices, the first feature may be signal to noise ratio, SNR, associated with the output signal and/or the microphone input signal. In one or more example audio devices, the first quality parameter may be based on the first score. In one or more example audio devices, the one or more input layers of the neural network may obtain the first score as input.

In one or more example audio devices, determine the one or more quality parameters comprises to determine a second score associated with a second feature of the output signal, wherein the first quality parameter is based on the second score.

In one or more example audio devices, the audio device may be configured to determine, using the non-intrusive quality detection model, the one or more quality parameters, such as the first quality parameter). In one or more example audio devices, determining the first quality parameter comprises determining a second score associated with the second feature of the output signal. In one or more example audio devices, determining the first quality parameter comprises determining a second score associated with the second feature of the microphone input signal (such as the microphone input signal from the first microphone). It is noted that the output signal and the microphone input signal may be seen as audio signals.

In one or more example audio devices, the second feature may be noisiness, associated with the output signal and/or the microphone input signal. In one or more example audio devices, the noisiness, such as coloration of the audio signal, discontinuity in the audio signal, loudness of the audio signal, and/or clarity of the audio signal, may be associated with human subjectivity, for example, the tolerance related to the loudness and/or the clarity of the output signal may be based on the far-end user during communication. One far-end user may perceive that the output signal is clear. However, a second user may perceive that the same output signal is unclear.

In one or more example audio devices, the first quality parameter may be based on the second score. In one or more example audio devices, the one or more input layers of the neural network may obtain the second score as input.

In one or more example audio devices, to determine the one or more quality parameters comprises to determine a third score associated with a third feature of the output signal, wherein the first quality parameter is based on the third score.

In one or more example audio devices, the audio device may be configured to determine, using the non-intrusive quality detection model, the one or more quality parameters, such as the first quality parameter. In one or more example audio devices, determining the first quality parameter comprises determining a third score associated with the third feature of the output signal. In one or more example audio devices, determining the first quality parameter comprises determining a third score associated with the third feature of the microphone input signal, such as the microphone input signal from the first microphone.

In one or more example audio devices, the third feature may be the speech clarity associated with the output signal and/or the microphone input signal. In one or more example audio devices, speech clarity may be seen as the clarity of the speech associated with the user of the audio device. In one or more examples, high speech clarity may be considered as the user's speech is clear to hear. In one or more examples, low speech clarity may be considered as the user's speech is not clear to hear.

In one or more example audio devices, the first quality parameter may be based on the third score. In one or more example audio devices, the one or more input layers of the neural network may obtain the third score as input.

In one or more example audio devices, determining the one or more quality parameters comprises to determine a fourth score associated with a fourth output feature of the output signal, wherein the first quality parameter is based on the fourth score.

In one or more example audio devices, the audio device may be configured to determine, using the non-intrusive quality detection model, the one or more quality parameters, such as the first quality parameter. In one or more example audio devices, determining the first quality parameter comprises determining a fourth score associated with the fourth feature of the output signal. In one or more example audio devices, determining the first quality parameter comprises determining a fourth score associated with the fourth feature of the microphone input signal, such as the microphone input signal from the first microphone.

In one or more example audio devices, the fourth feature may be the echo annoyance associated with the output signal and/or the microphone input signal. In one or more example audio devices, the first quality parameter may be based on the fourth score. In one or more example audio devices, the one or more input layers of the neural network may obtain the fourth score as input.

In one or more example audio devices, determining the one or more quality parameters comprises to determine a fifth score associated with a firth feature of the output signal, wherein the first quality parameter is based on the fifth score.

In one or more example audio devices, the audio device may be configured to determine, using the non-intrusive quality detection model, the one or more quality parameters, such as the first quality parameter. In one or more example audio devices, determining the first quality parameter comprises determining a fifth score associated with the fifth feature of the output signal. In one or more example audio devices, determining the first quality parameter comprises determining a fifth score associated with the fifth feature of the microphone input signal, such as the microphone input signal from the first microphone.

In one or more example audio devices, the fifth feature may be one or more of reverberation, delay properties due to room characteristics, spatial characteristics, and/or cue preservation associated with the output signal and/or the microphone input signal. In one or more example audio devices, the first quality parameter may be based on the fifth score. In one or more example audio devices, the one or more input layers of the neural network may obtain the fifth score as input.

In one or more example audio devices, determining the one or more quality parameters comprises to determine a combined score associated with two or more of the first feature, the second feature, the third feature, fourth feature and the fifth feature. In one or more example audio devices, the first quality parameter is based on the combined score.

In one or more example audio devices, determining the first quality parameter comprises determining a combined score based on two or more features, such as the first feature, the second feature, the third feature, the fourth feature, and fifth feature, of the output signal.

In one or more example audio devices, determining the second quality parameter comprises determining a combined score based on two or more features, such as the first feature, the second feature, the third feature, the fourth feature, and fifth feature, of the microphone input signal

In one or more example audio devices, determining the first quality parameter comprises determining a combined score based on the two or more features, such as the first feature, the second feature, the third feature, the fourth feature, and fifth feature, of the microphone input signal, such as the microphone input signal from the first microphone. In one or more example audio devices, the one or more input layers of the neural network may obtain the combined score as input.

In one or more example audio devices, determining one or more quality parameters including a first quality parameter indicative of a speech quality associated with the output signal is based on the output signal.

In one or more example audio devices, determining speech quality associated with the output signal is based on the output signal. In other words, the mean opinion score associated with the output signal may be based on the output signal alone.

In one or more example audio devices, determining one or more quality parameters including a first quality parameter indicative of a speech quality associated with the output signal is based on the microphone input signal.

In one or more example audio devices, determining speech quality associated with the output signal may be based on the microphone input signal, such as the microphone input signal from the first microphone. In other words, the mean opinion score associated with the output signal may be based on the microphone input signal alone.

In one or more example devices, the microphone input signal may be a combined microphone input signal from a first microphone and a microphone input signal from a second microphone.

In one or more example audio devices, the audio device may be configured to transmit the first quality parameter of the output signal along with the output signal. In one or more example audio devices, the audio device, such as far-end user audio device, may be configured to optimize, based on the received first quality parameter, the one or more features of the received audio signal, such as output signal from the audio device, with respect to the far-end user preferences.

In one or more example audio devices, the audio device may be configured to transmit the output signal and simultaneously determine the first quality parameter, such as MOS, associated with the output signal.

In one or more example audio devices, the audio device may be configured to speed up the output signal. It is an advantage of the present disclosure that speeding up the output signal during transmission compensates for the latency happening at the inference of the non-intrusive quality detection model.

In one or more example audio devices, the audio device may be configured to provide the one or more quality parameters, such as a first quality parameter, as feedback to the user of the audio device while using the audio device. In one or more example scenarios, the audio device receives feedback indicative of speech quality associated with the microphone input signal and/or the output signal.

In one or more example audio devices, the audio device may be configured to recommend, based on the one or more quality parameters, such as the first quality parameter, optimum speech quality needed for having a clear communication. In one or more example audio devices, recommending the optimum speech quality, based on the one or more quality parameters, such as the first quality parameter, comprises recommendations related to the suitability of the place, such as the room in which the user is using the audio device, for a communication.

An audio device is disclosed. The audio device may be configured to be worn at an ear of a user and may be a hearable or a hearing aid, wherein the processor is configured to compensate for a hearing loss of a user. In one or more example audio devices, the audio device may be one or more of a speaker phone, an audio-bar, a video-bar, and/or a mobile phone.

The audio device may be of the behind-the-ear (BTE) type, in-the-ear (ITE) type, in-the-canal (ITC) type, receiver-in-canal (RIC) type or receiver-in-the-ear (RITE) type. The hearing aid may be a binaural hearing aid. The audio device may comprise a first earpiece and a second earpiece, wherein the first earpiece and/or the second earpiece is an earpiece as disclosed herein.

The audio device may be configured for wireless communication with one or more devices, such as with another audio device, e.g., as part of a binaural audio or hearing system, and/or with one or more accessory devices, such as a smartphone and/or a smart watch. The audio device optionally comprises an antenna for converting one or more wireless input signals, e.g., a first wireless input signal and/or a second wireless input signal, to antenna output signal(s). The wireless input signal(s) may origin from external source(s), such as computer(s), laptop(s), tablet(s), smartphone(s), smartwatch(es), spouse microphone device(s), wireless TV audio transmitter, and/or a distributed microphone array associated with a wireless transmitter. The wireless input signal(s) may origin from another audio device, e.g., as part of a binaural audio or hearing system, and/or from one or more accessory devices.

The audio device comprises a processor for processing input signals, such as pre-processed transceiver input signal and/or pre-processed microphone input signal(s). The processor provides an electrical output signal based on the input signals to the processor. Input terminal(s) of the processor are optionally connected to respective output terminals of the pre-processing unit. For example, a transceiver input terminal of the processor may be connected to a transceiver output terminal of the pre-processing unit. One or more microphone input terminals of the processor may be connected to respective one or more microphone output terminals of the pre-processing unit.

The audio device comprises a processor for processing input signals, such as microphone input signal(s). The processor is optionally configured to compensate for hearing loss of a user of the audio device. The processor provides an output signal, such as an electrical output signal, based on the input signals to the processor.

It is noted that descriptions and features of audio device functionality, such as audio device configured to, also apply to methods and vice versa. For example, a description of an audio device configured to determine also applies to a method, e.g., of operating an audio device, wherein the method comprises determining and vice versa.

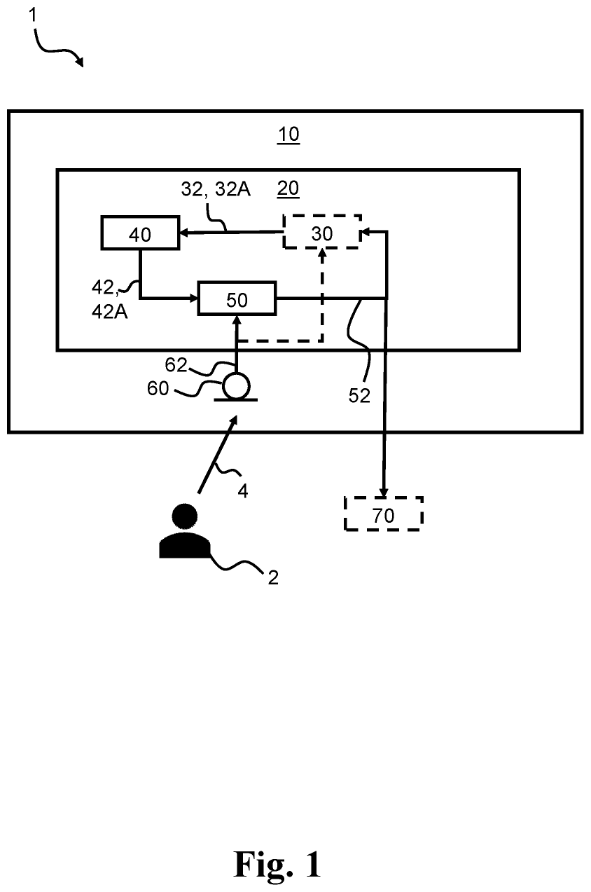

FIG. 1 schematically illustrates an example scenario with an audio device 10, such as a headset, an earpiece, a soundbar, or a smart speaker according to the present disclosure. The scenario 1 includes a speaker or user 2 wearing or close to the audio device.

In one or more example scenarios, the user or the speaker may present in the vicinity (e.g., within 10 meters radius) of the audio device 10.

The audio device comprises a memory storing a non-intrusive quality detection model, a first threshold, and/or at least one or more quality parameters generated by the quality detection model, one or more processors including processor 20, and an interface, and one or more microphones including a first microphone 60 for obtaining a first microphone input signal 62. The first microphone 60 may be arranged on a microphone boom. The interface comprises a wireless communication module comprising a radio transceiver and an antenna.

The scenario 1 includes the speaker 2. The speaker 2 may be seen as the user of the audio device 10 and when speaking, the speaker provides an audio signal 4. The audio signal 4 is detected by the microphone 60. The microphone 60 provides a microphone input signal 62. The processor 20 is configured to obtain the microphone input signal 62 based on the microphone 60. The processor 20 comprises a digital signal processing, DSP, module 50. The digital signal processing module 50 obtains the microphone input signal 62. The DSP module 50 is configured to perform speech enhancement, such as dereverberation, bandwidth extension, suppressing noise and/or echo in the microphone input signal 62. The DSP module 50 provides an output signal 52 based on the microphone input signal 62. The audio device 10 comprises a feature extraction module 30 also denoted feature extractor. In one or more example audio devices, the processor 20 comprises the feature extraction module 30. The feature extraction module 30 obtains the microphone input signal 62 and/or the output signal 52 from the DSP module 50. The feature extraction module extracts the features associated with the microphone input signal 62 and the output signal 52, respectively. The audio device 10 comprises a non-intrusive quality detection model 40, such as a machine learning model comprising a neural network. The neural network is an offline trained neural network.

The processor 20 is configured to determine, using the non-intrusive quality detection model 40, one or more quality parameters, including a first quality parameter 42 indicative of a speech quality associated with the output signal 52. In one or more example audio devices, the processor 20 is configured to determine, using the non-intrusive quality detection model 40, one or more quality parameters including a second quality parameter 42A indicative of a speech quality associated with the microphone input signal 62.

The processor 20/feature extractor 30 is configured to determine output features/scores 32 based on the first output signal 52 and/or input features/scores 32A based on the microphone input signal 64. The processor 20 is configured to determine, using the non-intrusive quality detection model 40, a first quality parameter 42 based on the output features 32. The first quality parameter is indicative of a mean opinion score associated with the first out signal 52. The processor 20 is optionally configured to determine, using the non-intrusive quality detection model 40, a second quality parameter 42A based on the input features 32A. The second quality parameter is indicative of a mean opinion score associated with the microphone input signal 62. The mean opinion score of a signal is indicative of the speech quality of the signal.

The processor 20 is configured to determine whether the mean opinion score associated with the output signal 52 (first quality parameter 42) and/or the mean opinion score associated with the microphone input signal 62 (second quality parameter 42A) is above a threshold value, such as a first threshold. The threshold value is predefined. In one or more example audio devices, the threshold value is dynamically determined by the audio device 10. The processor 20 is configured to control DSP block 50 based on whether the mean opinion score associated with the microphone input signal 62, or the signal 52 is above the threshold. The processor 20 is configured to, when the first quality parameter 42 is below the threshold, control DSP block 50 for provision of an output signal 52 with improved mean opinion score. The DSP block 50 is configured to control the processing of the microphone input signal 62, based on the first quality parameter 42 and/or the second quality parameter 42A, for provision of an output signal 52 with improved mean opinion score. In other words, improving the speech quality in the output signal.

The audio device 10 is configured to transmit, via the interface, the output signal 52 to an electronic device 70. The electronic device comprises a memory, a processor, an interface, one or more microphones, one or more speakers. The interface of the electronic device comprises a wireless communication module comprising a radio transceiver and antenna.

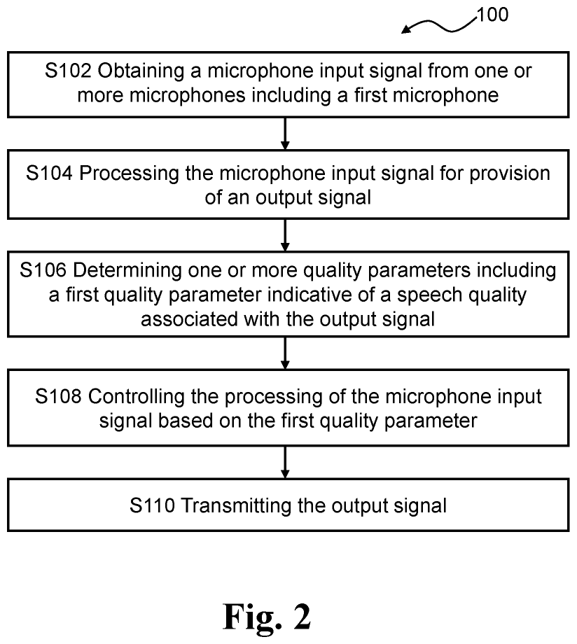

The audio device 10 may be configured to perform any of the methods disclosed in the FIG. 2.

The audio device may be configured for wireless communications via a wireless communication system, such as short-range wireless communications systems, such as Wi-Fi, Bluetooth, Zigbee, IEEE 802.11, IEEE 802.15, infrared and/or the like.

The audio system, and the audio device may be configured for wireless communications via a wireless communication system, such as a 3GPP system, such as a 3GPP system supporting one or more of: New Radio, NR, Narrow-band IoT, NB-IoT, and Long Term Evolution—enhanced Machine Type Communication, LTE-M, millimeter-wave communications, such as millimeter-wave communications in licensed bands, such as device-to-device millimeter-wave communications in licensed bands.

FIG. 2 is a flow diagram of an example method 100 for speech quality detection in an audio device. The method 100 may be performed by an audio device such as the audio device of FIG. 1.

The method 100 comprises obtaining S102 a microphone input signal from one or more microphones including a first microphone.

The method 100 comprises processing S104 the microphone input signal for provision of an output signal; determining S106 one or more quality parameters including a first quality parameter indicative of a speech quality associated with the output signal; controlling S108 the processing of the microphone input signal based on the first quality parameter; and transmitting S110 the output signal, e.g. to an electronic device.

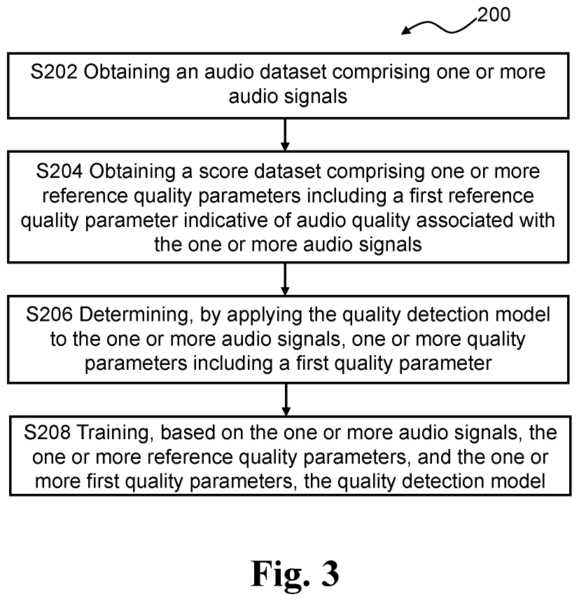

FIG. 3 is a flow diagram of an example computer-implemented method 200 for training a quality detection model for audio quality estimation. The method 200 may be performed by an audio device. The method 200 may be performed by an electronic device.

In one or more example methods, the method 200 may be performed in an electronic device, such as a mobile phone, an audio device, a tablet, a computer, a laptop, and/or a server device, such as a cloud server. The electronic device may comprise a processor, a memory, and an interface. The electronic device may comprise non-intrusive quality detection model in part of a memory.

The method 200 comprises obtaining S202 an audio dataset comprising one or more audio signals.

In one or more example methods, the one or more audio signals may comprise one or more of clean speech audio signals, speech signals affected by one or more interfering speeches, speech signals effected by noise, such as ambient noise, repetitive noise, low frequency noise, etc., noise signals, and far-field signals, such as jamming speech signals. It is noted that the signal may be seen as an audio signal. In one or more example methods, obtaining the audio dataset comprising obtaining the dataset from the memory of the electronic device.

The method 200 comprises obtaining S204 a score dataset comprising one or more reference quality parameters including a first reference quality parameter indicative of audio quality associated with the one or more audio signals.

In one or more example methods, the one or more reference quality parameters may be indicative of the mean opinion score associated with the one or more audio signals. In one or more example methods, the one or more reference quality parameters may be numerical values. In one or more example methods, obtaining the score dataset comprising obtaining the score dataset from the memory of the electronic device.

The method 200 comprises determining S206, by applying the quality detection model to the one or more audio signals, one or more quality parameters including a first quality parameter indicative of audio quality associated with the one or more audio signals.

In one or more example methods, the method comprises applying the quality detection model to the one or more audio signals. The quality detection model may be a non-intrusive quality detection model. The quality detection model may be a machine learning model comprising a neural network.

In one or more example methods, the method comprises determining, by applying the non-intrusive quality detection model, one or more first quality parameters associated with the one or more audio signals.

The method 200 comprises training S208, based on the one or more audio signals, the one or more reference quality parameters, and the one or more first quality parameters, the quality detection model.

In one or more example methods, the method comprises training the quality detection model, such as the non-intrusive quality detection model, based on the one or more audio signals, the one or more reference quality parameters associated with the one or more audio signals, and the one or more first quality parameters associated with the one or more audio signals.

In one or more example methods, the one or more input layers of the neural network may obtain the one or more reference quality parameters associated with the one or more audio signals and the one or more first quality parameters associated with the one or more audio signals as input.

In one or more example methods, the trained deep neural network may be applied to a microphone input signal in an audio device, such as the audio device 10 of FIG. 1.

In one or more example methods, the trained deep neural network may be applied to an output signal in an audio device, such as the audio device 10 of FIG. 1.

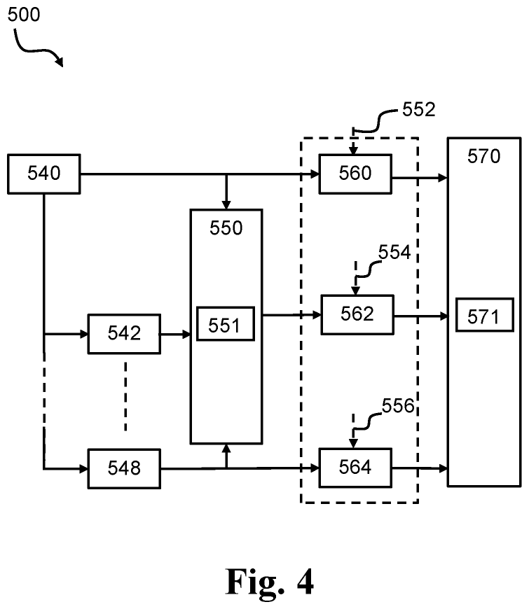

FIG. 4 shows a block diagram of an example system 500 for an audio dataset and a score dataset generation to train a quality detection model, e.g., quality detection model 40.

The system 500 may be a part of an electronic device. The system 500 comprises or is configured to obtain/receive a noise dataset 540. The noisy dataset 540 may be obtained from a memory, e.g., memory of the electronic device. The noisy dataset 540 is based on one or more noisy signal, such as noisy audio signals, such as speech signals with noise. The noisy dataset 540 comprises one or more noisy signals. The system 500 comprises one or more neural networks 542, 548, the neural networks are configured to process the one or more noisy signals from the noisy dataset 540. The one or more noise signals are fed to the one or more neural networks 542, 548. The system 500 comprises audio dataset generation module 550 for generating an audio dataset 551 based on the noisy dataset 540 and the output of the one or more neural networks 542, 548.

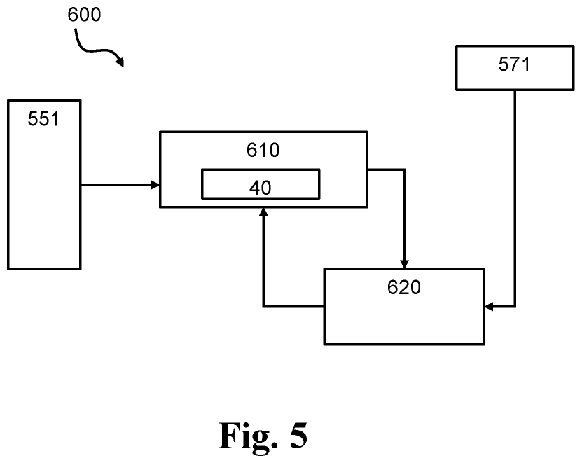

The system 500 comprises one or more speech quality metric modules 560, 562, 564. One or more speech quality metric modules are configured to receive a noisy signal from the noisy dataset 540, a clean audio signal 552, 554, 556, and a noisy signal from the audio dataset 551, for example, the quality metric module 560 is configured to receive a noisy signal from the noisy dataset 540 and a clean audio signal 560 to generate a quality parameter e.g., mean opinion score, MOS. The system 500 comprises a MOS module 570 to generate a score dataset 571 based on the quality parameters associated with the one or more noisy signals of the noisy dataset 540. The score dataset 571 and the audio dataset 551 may be used to train a quality detection model, e.g. as described in relation to FIG. 3 and/or FIG. 5. The target/labels can be produced e.g. via crowdsourcing subjective listening and/or by using some standardized multi-dimensional attributes of speech quality, such as noisiness, coloration, loudness, etc.

FIG. 5 shows a block diagram of an example training system 600 training a quality detection model, e.g., quality detection model 40.

The training system 600 may be a part of an electronic device e.g., electronic device 70. The training system 600 comprises or is configured to obtain/receive audio dataset 551. The training system 600 comprises a training module 610 comprises a quality detection model 40. The quality detection model 40 comprises a deep neural network architecture. The training system 600 comprises a cost function module 620 comprising a cost function. The cost function module 620 is configured to receive/obtain score dataset 571 comprising reference quality parameters associated with the audio dataset 551. The reference quality parameters (such as reference mean opinion scores) are indicative of mean opinion scores corresponding to the audio signals of the audio dataset 551. The training module 610 is configured to receive the audio dataset 551 and determine a quality parameter including a first quality parameter associated with one or more audio signals of audio dataset 551. The training module 610 outputs the first quality parameter to the cost function module 620. The cost function module 620 is configured to obtain the score dataset 571 and obtains the first quality parameter from the training module 610. based on the score dataset and the first quality parameter, the cost function module provides feedback to the training module 610. The trained deep neural network may be used to determine the speech quality/MOS of an audio signal, such as an output signal and/or a microphone signal, in an audio device as described herein.

Examples of audio devices and related methods according to the disclosure is set out in the following items:

Item 1. An audio device for speech quality detection, the audio device comprising an interface, a processor, and a memory, wherein the audio device is configured to:
obtain, via the interface, a microphone input signal from one or more microphones including a first microphone;
process the microphone input signal for provision of an output signal;
determine , using a non-intrusive quality detection model, one or more quality parameters including a first quality parameter indicative of a speech quality associated with the output signal;
control processing of the microphone input signal based on the first quality parameter; and
transmit, via the interface, the output signal.

Item 2. Audio device according to item 1, wherein the first quality parameter is a mean opinion score, and wherein the first quality parameter is indicative of one or more of speech distortion, noise attenuation, and echo annoyance.

Item 3. Audio device according to any one of items 1-2, wherein to determine the one or more quality parameters comprises to apply the non-intrusive quality detection model to a model input based on one or both of the output signal and the microphone input signal.

Item 4. Audio device according to any one of items 1-3, wherein to determine the one or more quality parameters comprises to determine an output quality parameter associated with the output signal and an input quality parameter associated with the microphone input signal, and wherein to determine the first quality parameter is based on the output quality parameter and the input quality parameter.

Item 5. Audio device according to any one of items 1-4, wherein the non-intrusive quality detection model comprises a machine leaning model comprising a trained neural network.

Item 6. Audio according to any one of items 1-5, wherein to process the microphone input signal for provision of an output signal comprises to apply a noise suppression scheme, and to control processing of the microphone input signal based on the first quality parameter comprises to control the noise suppression scheme based on the first quality parameter.

Item 7. Audio device according to any one of items 1-6, wherein to process the microphone input signal for provision of an output signal comprises to apply an echo cancellation scheme, and to control processing of the microphone input signal based on the first quality parameter comprises to control the echo cancellation scheme based on the first quality parameter.

Item 8. Audio device according to any one of items 1-7, wherein to determine the one or more quality parameters comprises to determine a first score associated with a first feature of the output signal, wherein the first quality parameter is based on the first score.

Item 9. Audio device according to any one of items 1-8, wherein to determine the one or more quality parameters comprises to determine a second score associated with a second feature of the output signal, wherein the first quality parameter is based on the second score.

Item 10. Audio device according to any one of items 1-9, wherein to determine the one or more quality parameters comprises to determine a third score associated with a third feature of the output signal, wherein the first quality parameter is based on the third score.

Item 11. Audio device according to any one of items 1-10, wherein to determine the one or more quality parameters comprises to determine a fourth score associated with a fourth feature of the output signal, wherein the first quality parameter is based on the fourth score.

Item 12. Audio device according to any one of items 1-11, wherein to determine the one or more quality parameters comprises to determine a fifth score associated with a firth feature of the output signal, wherein the first quality parameter is based on the fifth score.

Item 13. Audio device according to any one of items 1-12, wherein to determine the one or more quality parameters comprises to determine a combined score associated with two or more of the first feature, the second feature, the third feature, fourth feature and the fifth feature, wherein the first quality parameter is based on the combined score.

Item 14. Audio device according to any one of items 1-13, wherein to determine one or more quality parameters including a first quality parameter indicative of a speech quality associated with the output signal is based on the output signal.

Item 15. Audio device according to any one of items 1-14, wherein to determine one or more quality parameters including a first quality parameter indicative of a speech quality associated with the output signal is based on the microphone input signal.

Item 16. A method for speech quality detection in an audio device, wherein the method comprises:
obtaining a microphone input signal from one or more microphones including a first microphone;
processing the microphone input signal for provision of an output signal;
determining one or more quality parameters including a first quality parameter indicative of a speech quality associated with the output signal;
controlling the processing of the microphone input signal based on the first quality parameter; and
transmitting the output signal.

Item 17. A computer-implemented method for training a quality detection model for audio quality estimation, wherein the method comprises:
obtaining an audio dataset comprising one or more audio signals;
obtaining a score dataset comprising one or more reference quality parameters including a first reference quality parameter indicative of audio quality associated with the one or more audio signals;
determining, by applying the quality detection model to the one or more audio signals, one or more quality parameters including a first quality parameter indicative of audio quality associated with the one or more audio signals; and
training, based on the one or more audio signals, the one or more reference quality parameters, and the one or more first quality parameters, the quality detection model.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Furthermore, the labelling of a first element does not imply the presence of a second element and vice versa.

It may be appreciated that FIGS. 1-5 comprise some modules or operations which are illustrated with a solid line and some modules or operations which are illustrated with a dashed line. The modules or operations which are comprised in a solid line are modules or operations which are comprised in the broadest example embodiment. The modules or operations which are comprised in a dashed line are example embodiments which may be comprised in, or a part of, or are further modules or operations which may be taken in addition to the modules or operations of the solid line example embodiments. It should be appreciated that these operations need not be performed in order presented. Furthermore, it should be appreciated that not all of the operations need to be performed. The example operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the example embodiments may be implemented at least in part by means of both hardware and software, and that several “means”, “units” or “devices” may be represented by the same item of hardware.

The various example methods, devices, and systems described herein are described in the general context of method steps processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform specified tasks or implement specific abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

### LIST OF REFERENCES

1 scenario
2 speaker/user
4 audio signal
10 audio device
20 processors
30 feature extraction module/feature extractor
32 output features
32A input features
40 quality detection model, machine learning model
42 first quality parameter
42A second quality parameter
50 Digital Signal Processing (DSP) module
52 output signal
60 microphone
62 microphone input signal
70 electronic device
500 system
540 noisy dataset
542 neural network
548 neural network
550 audio dataset generation module
551 audio dataset
552, 554, 556 clean audio signals
560, 562, 564 quality metric modules
570 MOS module
571 score dataset
600 training system
610 training module
620 cost function module
S102 obtaining a microphone input signal from one or more microphones including a first microphone
S104 processing the microphone input signal for provision of an output signal
S106 determining one or more quality parameters including a first quality parameter indicative of a speech quality associated with the output signal
S108 controlling the processing of the microphone input signal based on the first quality parameter
S110 transmitting the output signal
S202 obtaining an audio dataset comprising one or more audio signals
S204 obtaining a score dataset comprising one or more reference quality parameters including a first reference quality parameter indicative of audio quality associated with the one or more audio signals
S206 determining, by applying the quality detection model to the one or more audio signals, one or more quality parameters including a first quality parameter
S208 training, based on the one or more audio signals, the one or more reference quality parameters, and the one or more first quality parameters, the quality detection model

1. An audio device for speech quality detection, the audio device comprising an interface, a processor, and a memory, wherein the audio device is configured to:
obtain, via the interface, a microphone input signal from one or more microphones including a first microphone;
process the microphone input signal for provision of an output signal;
determine, using a non-intrusive quality detection model, one or more quality parameters including a first quality parameter indicative of a speech quality associated with the output signal;
control processing of the microphone input signal based on the first quality parameter; and
transmit, via the interface, the output signal.

2. Audio device according to claim 1, wherein the first quality parameter is a mean opinion score, and wherein the first quality parameter is indicative of one or more of speech distortion, noise attenuation, and echo annoyance.

3. Audio device according to claim 1, wherein to determine the one or more quality parameters comprises to apply the non-intrusive quality detection model to a model input based on one or both of the output signal and the microphone input signal.

4. Audio device according to claim 1, wherein to determine the one or more quality parameters comprises to determine an output quality parameter associated with the output signal and an input quality parameter associated with the microphone input signal, and wherein to determine the first quality parameter is based on the output quality parameter and the input quality parameter.

5. Audio device according to claim 1, wherein the non-intrusive quality detection model comprises a machine learning model comprising a trained neural network.

6. Audio according to claim 1, wherein to process the microphone input signal for provision of an output signal comprises to apply a noise suppression scheme, and to control processing of the microphone input signal based on the first quality parameter comprises to control the noise suppression scheme based on the first quality parameter.

7. Audio device according to claim 1, wherein to process the microphone input signal for provision of an output signal comprises to apply an echo cancellation scheme, and to control processing of the microphone input signal based on the first quality parameter comprises to control the echo cancellation scheme based on the first quality parameter.

8. Audio device according to claim 1, wherein to determine the one or more quality parameters comprises to determine a first score associated with a first feature of the output signal, wherein the first quality parameter is based on the first score.

9. Audio device according to claim 1, wherein to determine the one or more quality parameters comprises to determine a second score associated with a second feature of the output signal, wherein the first quality parameter is based on the second score.

10. Audio device according to claim 1, wherein to determine the one or more quality parameters comprises to determine a third score associated with a third feature of the output signal, wherein the first quality parameter is based on the third score.

11. Audio device according to claim 1, wherein to determine the one or more quality parameters comprises to determine a combined score associated with two or more of the first feature, the second feature, and the third feature, wherein the first quality parameter is based on the combined score.

12. Audio device according to claim 1, wherein to determine one or more quality parameters including a first quality parameter indicative of a speech quality associated with the output signal is based on the output signal.

13. Audio device according to claim 1, wherein to determine one or more quality parameters including a first quality parameter indicative of a speech quality associated with the output signal is based on the microphone input signal.

14. A method for speech quality detection in an audio device, wherein the method comprises:
obtaining a microphone input signal from one or more microphones including a first microphone;
processing the microphone input signal for provision of an output signal;
determining one or more quality parameters including a first quality parameter indicative of a speech quality associated with the output signal;
controlling the processing of the microphone input signal based on the first quality parameter; and
transmitting the output signal.

15. A computer-implemented method for training a quality detection model for audio quality estimation, wherein the method comprises:
obtaining an audio dataset comprising one or more audio signals;
obtaining a score dataset comprising one or more reference quality parameters including a first reference quality parameter indicative of audio quality associated with the one or more audio signals;
determining, by applying the quality detection model to the one or more audio signals, one or more quality parameters including a first quality parameter indicative of audio quality associated with the one or more audio signals; and
training, based on the one or more audio signals, the one or more reference quality parameters, and the one or more first quality parameters, the quality detection model.
